(19) United States
(12) Patent Application Publication
(10) Pub. No.: US 2006/0201598 A1
(43) Pub. Date: Sep. 14, 2006

(54) Tire inflation maintenance apparatus

(76) Inventors: Richard D. Rheinhardt, Pocasset, MA (US); Richard M. Rheinhardt, Lady Lake, FL (US)

Correspondence Address: BOWERS HARRISON LLP;GARY K. PRICE, ESP., 25 RIVERSIDE DRIVE, PO BOX 1287, EVANSVILLE, IN, 47706-1287, US

(21) Appl. No.: 11/076,151

(22) Filed: Mar. 8, 2005

(51) Int. Cl. B60C 23/10

(52) U.S. Cl. 152/418

(57) ABSTRACT

An apparatus that mounts on an outer surface of a rim of a vehicle wheel on which a tire can be mounted. The apparatus includes a high pressure reservoir for receiving and storing compressed air from an outside source, a first mechanical valve that permits compressed air from an outside source to be directed into and stored in the high pressure reservoir, a second mechanical valve that directs air from the high pressure reservoir into the extended tire air chamber of a tire, a third mechanical valve that releases air from the extended tire air chamber of the tire, a fourth mechanical valve that releases air from the high pressure reservoir, and a fitting that provides a pressure tight conduit from the tire's air chamber to the extended tire air chamber of the apparatus.

### CROSS REFERENCES TO RELATED APPLICATIONS

None.

Statement as to rights to inventions made under Federally sponsored research and development: Not Applicable

### BACKGROUND OF THE INVENTION

1. Field of the Invention

This invention is an apparatus for regulating the amount of air pressure in a tire, and particularly to the inclusion of a high pressure reservoir fastened to the outside of a rim of a vehicle wheel. The apparatus automatically maintains air pressure within a pre-selected range. When pressure within the tire drops below the selected threshold, air is directed from the high pressure reservoir into the tire keeping it inflated to the desired minimum pressure; and, when pressure rises above the selected threshold in the tire, air is released from the tire into the atmosphere.

2. Background Information

An improperly inflated automobile tire is a safety hazard. Maintaining proper air pressure in an automobile tire (and other type vehicles) also increases fuel efficiency and maximizes tire life. A large percentage of vehicles are running on under inflated tires. This is due to the fact that tires commonly lose air at a relatively slow rate and owners defer the recommended monthly pressure check and inflation.

It is well known to attach an electronic tire pressure sensor to a rim of a vehicle wheel to sense pressure within a tire chamber. Such a tire pressure sensor contains a power source, such as a battery, and signals a vehicle driver if pressure in the tire becomes too low. In order to obtain the proper pressure within the tire chamber when the tire pressure becomes too low, air must be either manually or electronically transferred to the tire air chamber from some external air supply. The problem with relying on an air supply separate from the vehicle wheel is that it may not be available to the user when needed, or it may require a power source that is susceptible to damage or not available when the air pressure in the tire is low.

Although an apparatus for mounting a pressure sensor on a rim of the vehicle is known, such prior art does not include a high pressure reservoir mounted to the outside of the wheel rim for supplying air to the tire when the tire pressure becomes too low. As such, prior art sensors may signals the vehicle driver when the pressure is too low, but such apparatus are unable to supply air to the tire to prevent the pressure from becoming too low in the first place.

As will be seen from the subsequent description, the preferred embodiment of the present invention overcomes these and other shortcomings of prior art.

### SUMMARY OF THE INVENTION

The present invention is designed to mount on the outside of a vehicle wheel rim on which a tire is mounted. The apparatus of the present invention mechanically maintains tire pressure within a pre-selected range, alleviating the need for the vehicle operator to manually inflate a tire to achieve the desired pressure. When pressure within the tire drops below a selected threshold, air stored in the apparatus' high pressure reservoir is released into the tire keeping it inflated to the desired minimum pressure; and, when pressure in the tire rises above the selected threshold, air is released from the tire into the atmosphere. The preferred embodiment includes an air inlet valve for receiving compressed air from an outside source into a high pressure reservoir mounted on the outside of the rim of the vehicle wheel, an air pressure regulator valve to transfer the air from the high pressure reservoir into a vehicle's extended tire air chamber, a release valve to let air out of the high pressure reservoir, if necessary, and a pressure activated air release valve to let air out of the vehicle's extended tire air chamber, when necessary.

### BRIEF DESCRIPTION OF THE DRAWINGS

FIG. 1 is a cross-sectional view of the components of a preferred embodiment of the present invention, a tire inflation maintenance apparatus fastened to the outside of a wheel rim.

FIG. 2 is an enlarged view of a portion of the apparatus of FIG. 1.

### DESCRIPTION OF THE PREFERRED EMBODIMENTS

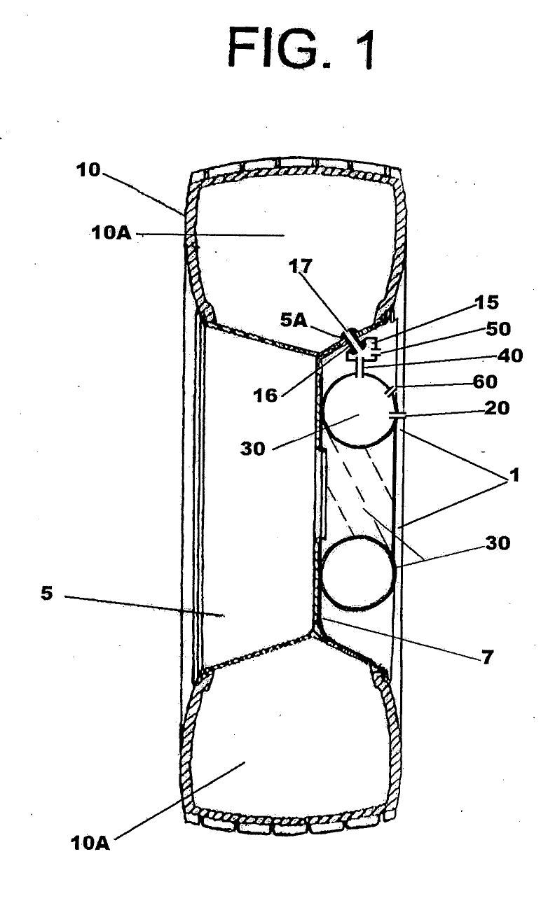

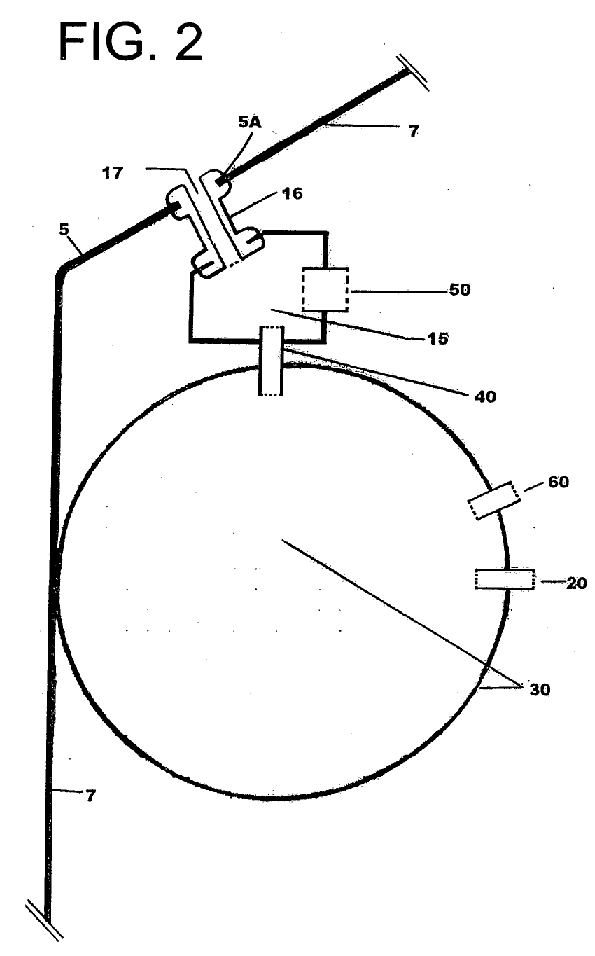

FIGS. 1-2 illustrate a preferred embodiment of a tire inflation maintenance apparatus 1 made in accordance with the present invention. The tire inflation maintenance apparatus 1 includes a high pressure reservoir 30 that is mounted on an outer surface 7 of a rim 5 of a vehicle wheel on which a tire 10 having an air chamber 10A is mounted.

The tire inflation maintenance apparatus 1 is mounted to the outer surface 7 of the rim 5 preferably using existing lug bolts (not shown), or other mounting means known in the art. As shown in FIG. 1, the tire inflation maintenance apparatus 1 generally includes the high pressure reservoir 30, an extended tire air chamber 15, an air inlet valve 20, an air pressure regulator valve 40, a pressure activated air release valve 50, and a pressure activated air release valve 60.

The air inlet valve 20 outwardly projects from the high pressure reservoir 30 and permits compressed air (not shown) from an outside source to be directed into and stored in the high pressure reservoir 30. The air inlet valve 20 is easily accessible from the outside of the tire inflation maintenance apparatus 1 for receiving the air from the outside source. The high pressure reservoir 30 is mounted to the outer surface 7 of the rim 5 and stores the compressed air received from the outside source.

The high pressure reservoir 30 can be constructed of any number of lightweight materials, such as, but not limited to, steel, plastic, aluminum, titanium, or steel-belted tire-like materials.

The air pressure regulator valve 40 projects from the high pressure reservoir 30 and directs air from the high pressure reservoir 30 to the extended tire air chamber 15. The air pressure regulator valve 40 includes mechanical activation means that when activated, transfers the air stored in the high pressure reservoir 30 to the extended tire air chamber 15. Air flows from the high pressure reservoir 30 into the extended tire air chamber 15 when the pressure in the extended tire air chamber 15 (as well as in tire air chamber 10A) drops below a pre-selected pressure activation threshold. The said mechanical means to activate the air regulator valve 40 at the pre-selected pressure is known.

A fitting 16 extends through an existing opening 5A in the rim 5, into the air chamber 10A of the tire 10. The fitting 16 defines an internal passage 17 between the air chamber 10A of the tire 10 and the extended tire air chamber 15. The fitting 16 forms a pressure-tight conduit from the tire air chamber 10A through the opening 17 in the rim 5A and from there into the extended tire air chamber 15. As such, the tire air chamber 10A is in continuous pneumatic communication with the extended tire air chamber 15.

The fitting 16 and extended tire air chamber 15 can be constructed of any number of lightweight materials, such as, but not limited to, steel, plastic, aluminum, titanium, rubber, or steel-belted tire-like materials.

The pressure activated air release valve 50 outwardly projects from the extended tire air chamber 15. The pressure activated air release valve 50 includes mechanical activation means that when activated, releases the air pressure from the extended tire air chamber 15 into the atmosphere. The pressure activated air release valve 50 is activated when the air pressure in the extended tire air chamber 15 (as well as in tire air chamber 10A) exceed a pre-selected pressure threshold. The mechanical activation means to activate the pressure activated air release valve 50 at the pre-selected pressure threshold is known.

The pressure activated air release valve 60 outwardly projects from the high pressure reservoir 30. The pressure activated air release valve 60 includes mechanical activation means that when activated, releases air stored in the high pressure reservoir 30 into the atmosphere. The pressure activated air release valve 60 is activated when air pressure in the high pressure reservoir 30 exceeds a pre-selected pressure threshold. The said mechanical activation means to activate the pressure activated air release valve 60 at the pre-selected pressure threshold is known.

Although the description herein refers primarily to said mechanical activation means that activates the valves 20, 40, 50 and 60, it is understood by one skilled in the art that such mechanical means may be replaced with electronic pressure sensors for each of the valves that provide signals for electrically opening and closing the valves.

The air inlet valve 20, the air pressure regulator valve 40, the pressure activated air release valve 50, and the pressure activated air release valve 60, having the above-described mechanical activation means, may be obtained from a variety of vendors or can be assembled with modified valve parts already available in the art. A set of air valves with the desired pre-selected opening and closing specifications can be chosen to match the pressure range requirements of any tire to be mounted on the wheel rim. The specific valves or valve parts can also be chosen to withstand conditions normally associated with a rapidly spinning wheel, including, but not limited to, centripetal forces, road shock, dirt, water, and changes in temperatures resulting from weather and/or frictional heat.

It should be understood by one skilled in the art that the functions of the air inlet valve 20 and the pressure activated air release valve 60 may be combined into a single valve. In this regard, the functions of the air regulator valve 40 and the pressure activated air release valve 60 may likewise be combined. It should be further understood that although the description herein describes the valves 50 and 60 as being pressure activated, it is obvious that such valves may be manually activated to release air as well.

It should be further understood that as the extended tire air chamber 15 is in pneumatic communication with the air chamber 10A of the tire 10, the air pressure within the extended tire air chamber 15 remains equal to the air pressure within the air chamber 10A.

Although the description above contains many specificities, these should not be construed as limiting the scope of the invention but as merely providing illustrations of some of the presently preferred embodiments of this invention. For example, the tire inflation maintenance apparatus 1 disclosed herein can be mounted to the outer surface 7 of the rim 5 as described or can be integral to a wheel cover (not shown) that is commonly mounted to the rim 5 using bolts.

Thus the scope of the invention should be determined by the appended claims in the formal application and their legal equivalents, rather than by the examples given.

I claim:

1. An apparatus for mounting on a rim of a vehicle wheel on which a tire can be mounted, said apparatus comprising:
a high pressure reservoir, a fitting, an extended tire air chamber, an air inlet valve, an air pressure regulator valve, a first pressure activated air release valve, and a second pressure activated air release valve;
wherein the air inlet valve projects from the high pressure reservoir, said air inlet valve for receiving compressed air from an outside source that is stored in the high pressure reservoir;
wherein the fitting extends through an opening in the rim into the tire air chamber, said fitting defines a passage between the tire's air chamber and the extended tire air chamber;
wherein the air regulator valve projects from the high pressure reservoir and directs air from the high pressure reservoir to the extended tire air chamber;
wherein the first pressure activated release valve senses the pressure in the extended tire air chamber and releases the air from the extended tire air chamber;
wherein the second pressure activated release valve senses the air pressure in the high pressure reservoir and releases the air from the high pressure reservoir.

2. The apparatus as recited in claim 1, wherein the first pressure activated air release valve is disposed between the fitting and the air pressure regulator valve and projects from the extended tire air chamber to the atmosphere.

3. The apparatus as recited in claim 1, wherein the second pressure activated air release valve projects from the high pressure reservoir into the atmosphere.

4. The apparatus as recited in claim 1, wherein said fitting forms a pressure tight conduit from the tire air chamber to the extended tire air chamber.

5. The apparatus as recited in claim 1, wherein the air inlet valve, the air pressure regulator valve, and the first and second pressure activated air release valves each include mechanical activating pressure sensors that are mechanically activated.

6. The apparatus as recited in claim 1, wherein the air inlet valve, the air pressure regulator valve, and the first and second pressure activated air release valves each include electronic pressure sensors and electrically operated valves.

7. The apparatus as recited in claim 1, wherein the air inlet valve and the second pressure activated air release valve is a single valve.

8. The apparatus as recited in claim 1, wherein the air pressure within the extended tire air chamber equals the air pressure within the tire's air chamber.

9. The apparatus as recited in claim 1 wherein the apparatus is mounted on an outer surface of the rim.

10. An apparatus for mounting on an outer surface of a rim of a vehicle wheel on which a tire can be mounted, said apparatus comprising:
a high pressure reservoir,
an extended tire air chamber that is in continuous pneumatic communication with the tire air chamber,
a fitting disposed between a tire's air chamber and the extended tire air chamber, wherein said fitting defines a passage between the extended tire air chamber and the tire's air chamber,
a first valve, said first valve for receiving compressed air from an outside source that is stored in the high pressure reservoir,
a second valve, said second valve directs the compressed air from the high pressure reservoir from the extended tire air chamber and the tire's air chamber,
a third valve for sensing the pressure within the extended tire air chamber (and tire air chamber) and releasing the air from the extended tire air chamber to the atmosphere,
a fourth valve for sensing the air pressure within the high pressure reservoir and releasing the air from the high pressure reservoir to the atmosphere.

11. The apparatus as recited in claim 10, wherein the third valve is projects from the extended tire air chamber to the atmosphere.

12. The apparatus as recited in claim 10, wherein the fourth valve projects from the high pressure reservoir to the atmosphere.

13. The apparatus as recited in claim 10, wherein said fitting forms a pressure tight conduit from the tire's air chamber to the extended tire air chamber.

14. The apparatus as recited in claim 10, wherein the first, second, third and fourth valves include mechanical activating pressure sensors.

15. The apparatus as recited in claim 10, wherein the first, second, third and fourth valves are electrically operated by electronic pressure sensors.
